(19) United States
(12) Patent Application Publication
(10) Pub. No.: US 2022/0205842 A1
(43) Pub. Date: Jun. 30, 2022

(54) A NON-CONTACT TEMPERATURE SENSOR

(71) Applicant: IMPRESSION TECHNOLOGIES LIMITED, Coventry (GB)

(72) Inventors: Alistair David FOSTER, Coventry (GB); Federico MELOTTI, Coventry (GB)

(21) Appl. No.: 17/599,629

(22) PCT Filed: Apr. 2, 2020
(86) PCT No.: PCT/GB2020/050883

§ 371 Date: Sep. 29, 2021

(30) Foreign Application Priority Data
Apr. 2, 2019 (GB) 1904649.9

(51) Int. Cl. G01J 5/0806; G01J 5/08; G01J 5/20

(52) U.S. Cl. CPC G01J 5/0806; G01J 5/085; G01J 2005/607; G01J 5/20; G01J 5/0887; G01J 5/0896

(57) ABSTRACT

A non-contact temperature sensor (1) suitable for use in measuring the temperature of a material blank (3). The temperature sensor (1) comprises a housing (5), an opening (7) at the forward end of the housing (5), a reflector (13) that is located within the housing (5), at least one aperture (15) that is located between the forward surface and the rearward surface of the reflector (13) and a light detector arrangement (17) located rearward of the reflector (13). The light detector arrangement (17) is orientated such that it can receive light passing through the at least one aperture (15) and it is capable of detecting at least two ranges of wavelengths of infrared light. The light detector arrangement (17) outputs data for each of the at least two ranges of wavelengths of infrared light.

The present invention relates to a non-contact temperature sensor for measuring a temperature of a surface and relates particularly, but not exclusively, to a sensor for measuring the temperature of a point on a surface of a metal blank, prior to that blank being subjected to a forming process, such as pressing. A metal blank is a thin sheet of metal, such as aluminium, which is cut to a predefined shape and which is the input material to a forming process.

In the Applicant's Hot Form Quench (HFQ) process there is a need to obtain a very accurate temperature measurement of a local reference temperature of an aluminium alloy blank that is typically between 400 degrees Celsius and 600 degrees Celsius. A very accurate temperature measurement is considered to be +/−3 degrees Celsius within a range of 400 degrees Celsius to 600 degrees Celsius. Very accurate temperature measurement is required in order to (i) monitor production temperature repeatability and reproducibility of a material tempering process; (ii) ensure that the forming process is undertaken when the blank is at the correct temperature; (iii) monitor the cooling of the blank; and (iv) ensure that the heating process works in the desired manner. This ensures that the process is successful, i.e. that the finished formed article is to specification. The temperature sensors that are currently available for non-contact measurement of the temperature of a blank are not suitable for use in the Applicant's forming process, because they cannot reliably measure the temperature to a sufficient degree of accuracy.

In addition to application to the Applicant's HFQ process, the present invention is suitable to application to other processes in which accurate temperature measurement is required.

There exists a plethora of methods to find the temperature of a hot object and yet they each have significant disadvantages when applied to the Applicant's process.

Broadly, the measurement methods can be categorised into two groups. Contact methods such as thermocouples and thermistors and non-contact methods such as pyrometers that exploit the temperature dependence of the spectral density of light emitted by an object. The term light is used here to mean the spectral regions of electromagnetic radiation that include the spectrum of visible light and the adjacent regions, i.e. infrared radiation at one end through to ultraviolet radiation at the other end. The present application relates to an invention within the second category of measurement methods.

An accurate contact measuring system requires good contact with the surface of the hot object. That contact may be achieved by welding or cementing, but such methods are destructive to the surface of the component and are cost-prohibitive when scaled to a production system. A spring system may be used to provide a non-permanent force contact, but such a contact is sensitive to the build-up of dirt on the contact surfaces and is susceptible to mechanical wear. Thus, it is also not suitable for the production environment.

To overcome the issues of contact measuring systems, many industrial processes use thermal radiation (electromagnetic infrared radiation) pyrometers to indirectly measure component temperature without the sensor contacting the component. Pyrometers of this type measure, over a defined wavelength range, the thermal radiation given off by the object's surface. The radiation energy is then converted into a temperature according to the known relationship between surface temperature and the emitted radiation energy. The aforementioned relationship is material-dependent according to the object's surface properties. This material dependence is often simplified to a single scalar term, called the surface emissivity.

Existing systems for measuring the temperature of aluminium alloys during their processing, such as are used on rolling mills, comprise a number of pyrometers located along the path of the aluminium alloy as it passes through the mill. In a rolling mill environment, temperature readings that are sufficiently accurate to allow good control of the process can be readily obtained using existing temperature sensors, because the surface of the aluminium alloy passing through the mill is well controlled and has known characteristics. In contrast, the aluminium alloy blanks that the Applicant wishes to process come from different rolling mills, thus are subjected to different manufacturing processes and as a result have different physical characteristics. The existing temperature measurement sensors are not able to compensate sufficiently well for the variations in the physical and chemical characteristics that influence the material's emissivity. In particular, the existing sensors cannot adequately compensate for variations in the surface emissivity that occur within a single blank and between different blanks. Those differences in emissivity result from, for example, variation in the surface roughness across a sheet (or from one sheet compared to another), or the composition and thickness of the oxide layer that forms on the surface of the aluminium alloy, which can vary with time.

If the instantaneous emissivity of the blank could be accurately determined over the wavelengths used by the pyrometer, then that emissivity could be used to improve the accuracy of the temperature calculation from the thermal radiation readings. Likewise, if a more comprehensive means could be identified to map the thermal radiation readings to the associated blank temperature, then the accuracy of the pyrometer could be improved. However, determining such correlations currently requires expensive equipment that is not suited to deliver instantaneous readings in a production environment. Instead, the present invention uses a number of techniques to manipulate the thermal radiation emitted by the blank, such that the intensity of the thermal radiation detected by the pyrometer, and the calculation of corresponding surface temperature, is less sensitive to the surface emissivity of the blank, whilst remaining at least as sensitive to the temperature variation of the spectrum of thermal radiation of the blank.

In order to determine the accuracy of the temperature measurement the Applicant has implemented a system in which the non-contact temperature sensor can have a self error estimation functionality.

The temperature sensor of the present invention is for use as part of a quality assurance system comprised also of a visible light camera and an infrared camera. In that system the temperature sensor measures the temperature of a reference area and the system uses that temperature measurement to calibrate a thermal map which has been created with the use of the infrared camera.

It is an object of the present invention to provide a high accuracy non-contact temperature sensor suitable for measuring the temperature of a metal blank.

Accordingly, the present invention provides a non-contact temperature sensor having a longitudinal axis X-X comprising: a housing; an opening at the forward end of the housing; a reflector that is located within the housing; at least one aperture that is located between the forward surface and the rearward surface of the reflector; a light detector arrangement located rearward of the reflector; wherein the light detector arrangement is orientated such that it can receive light passing through the at least one aperture; and wherein the light detector arrangement is capable of for detecting at least two ranges of wavelengths of infrared light, a first range of wavelengths of infrared light and a second range of wavelengths of infrared light, the first and second ranges of wavelengths of infrared light being discrete, wherein the light detector arrangement outputs data for each of the at least two ranges of wavelengths of infrared light. The data output by the light detector arrangement is a digital or analogue representation of a signal.

In a preferred embodiment the non-contact temperature sensor further comprises an infrared light source.

Preferably, there are two infrared light sources, a first infrared light source that can generate infrared light at a first wavelength and a second infrared light source that can generate infrared light at a second wavelength.

The first and second wavelengths of infrared light generated by the infrared light sources are respectively within the first range of wavelengths of infrared light and the second range of wavelengths of infrared light that are detectable by the light detector arrangement.

Preferably, the infrared light sources are located forward of the mirror.

Preferably, the infrared light sources comprise a plurality of separate infrared light emitting devices arranged individually, or in discrete groups, and orientated so that the individual infrared light emitting devices or the discrete groups of infrared light emitting devices are spaced apart from each other.

Preferably, the plurality of separate infrared light emitting devices are located on the forward facing side of a narrow annular platform that is orientated transversally to axis X-X and aligned co-axially with longitudinal axis X-X.

The light detector arrangement may be an arrangement of two or more discrete light detectors within a single light detection module, wherein one of the two or more discrete light detectors is capable of detecting infrared light within the first range of wavelengths of infrared light and wherein the other of the two or more discrete light detectors is capable of detecting infrared light within the second range of wavelengths of infrared light.

The light detector arrangement may alternatively be an arrangement of two or more discrete light detectors, each detector within a separate light detection module, wherein one of the two or more discrete light detectors is capable of detecting infrared light within the first range of wavelengths of infrared light and wherein the other of the two or more discrete light detectors is capable of detecting infrared light within the second range of wavelengths of infrared light.

Advantageously, the non-contact temperature sensor further comprises at least one lens aligned with the longitudinal axis X-X and located adjacent to and rearward of the at least one aperture.

Advantageously, the at least one lens is a planar-concave lens aligned with the longitudinal axis X-X, or aligned with an axis parallel to the longitudinal axis X-X, and located rearward of the at least one aperture.

In order to provide a further advantage, at least one bi-convex lens aligned with the longitudinal axis X-X, or aligned with an axis parallel to the longitudinal axis X-X, and located rearward of the at least one aperture is also provided.

Providing a planar-concave lens and a bi-convex lens ensures that light focussed by the dual lens arrangement is incident upon the infrared detector such that the whole of sensor head is irradiated. This reduces the introduction of measurement errors and thus assists with ensuring a high accuracy for the temperature sensor.

Preferably, the reflector is a concave mirror. However, the mirror may have a different form, for example the mirror may be flat.

Preferably, the mirror has a focal point (FP) that is outside of the housing.

The focal point (FP) of the mirror is advantageously positioned at a distance of between 50 mm and 100 mm from the forward face of the housing.

Preferably the light detector uses photodiode sensors such as InGaAs photodiodes. Alternatively, the light detector may use thermopile sensors.

Preferably the light detector is orientated in a direct line of sight with the at least one aperture.

Preferably the opening is a window made from a high transmissivity material. Alternatively, the opening may be provided with a supply of air to prevent the ingress of foreign objects, such as dust, into the housing.

Preferably there is also provided a visible light source that can generate light in the visible range, wherein the visible light from the visible source is directed in a forward direction.

Preferably there is also provided a controller for controlling the light emitting devices. More preferably, the controller is capable of rapid switching of the light emitting devices between an ON state to an OFF state.

The independent detection of infrared radiation over two discrete wavelength ranges is beneficial when compared to the detection over a single wavelength range as the amplitude of the two signals will vary differently with temperature according to a predictable relationship. This means the relationship between the two signal magnitudes can be used to calculate the blank temperature rather than relying solely on the magnitude of a single wavelength detector.

Such methods are well known but typically rely on the assumption that the blank emissivity is i) a singular value for both wavelengths and ii) constant within a tight range after off-line calibration. The applicants have discovered that, by using a reflector, such as a reflective disk or mirror to enhance the apparent emissivity of the blank, the relative magnitudes of the two wavelength ranges are less sensitive to variations in the emissivity of the blank between the two wavelength ranges. It has been discovered by the applicants that this has the beneficial result of improving the accuracy of former method when applied to the Applicant's industrial application.

Preferably the detector is sensitive to the near-infrared (NIR) and short-wave infrared (SWIR) radiation wavelengths. These spectrums are beneficial because uncoated aluminium, heated to a temperature of several hundred degrees Celsius, typically has a higher spectral energy in these regions than at mid-infrared (MWIR) or long-infrared (LWIR) radiation wavelengths. Over the temperature range considered, the NIR and SWIR wavelength bands provide a required characteristic whereby the difference in power radiated from a surface at two discreet wavelength ranges is a strong function of the temperature of the surface.

Preferably the first and second wavelength spectrums detected by the detector are selected so as to avoid wavelengths substantially absorbed by constituents of air, such as H2O and CO2.

Preferably, the light detector is orientated in a direct line of sight with the aperture.

Aspects of the present invention will now be more particularly described by way of example only with reference to the following drawings in which:

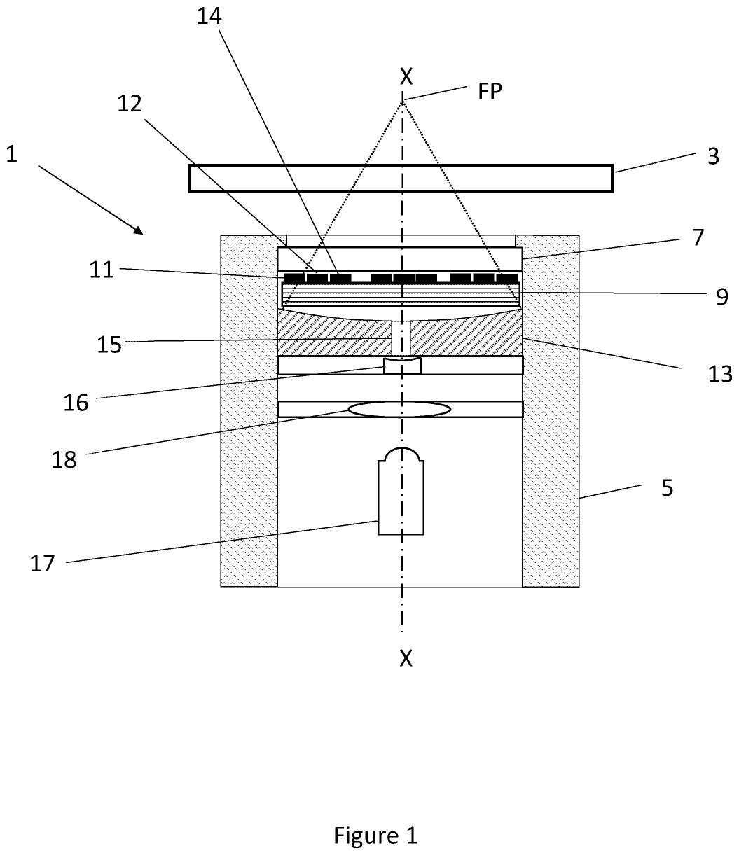

FIG. 1 is a cross-sectional diagrammatic representation of a first embodiment of a non-contact temperature sensor;

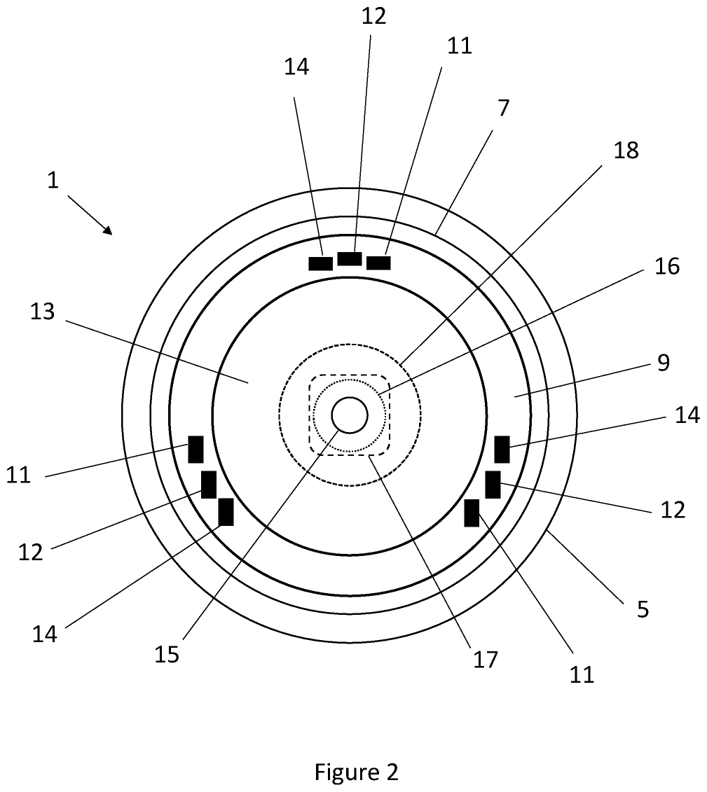

FIG. 2 is a plan view of a diagrammatic representation of a first embodiment of a non-contact temperature sensor;

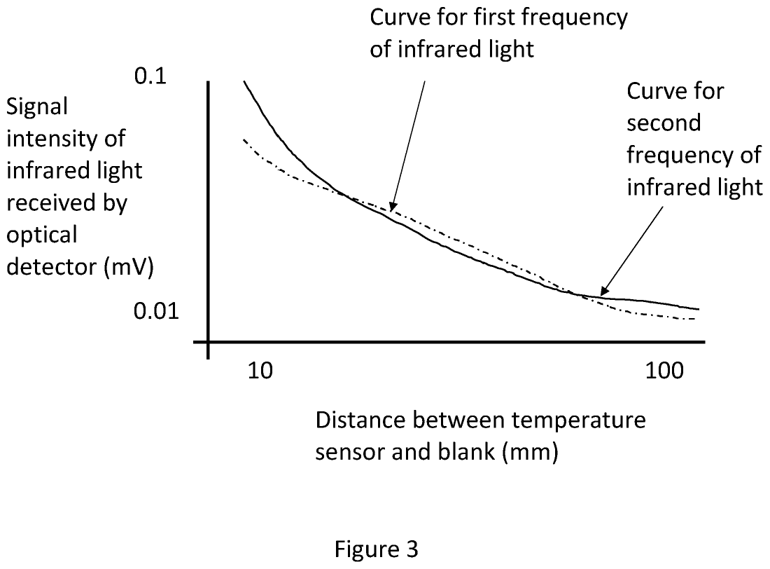

FIG. 3 is a graph showing a relationship between distance and sensor signal;

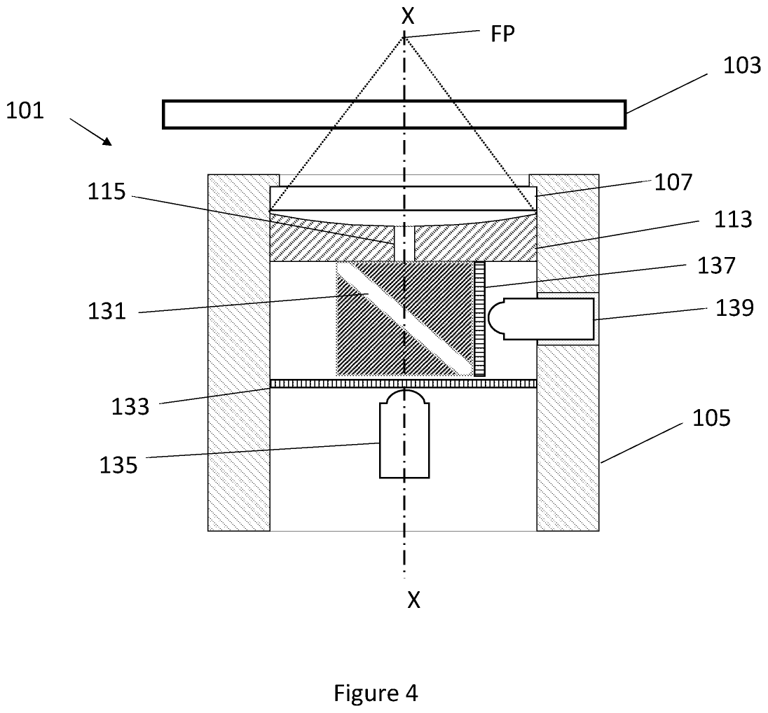

FIG. 4 is a cross-sectional diagrammatic representation of a second embodiment of a non-contact temperature sensor;

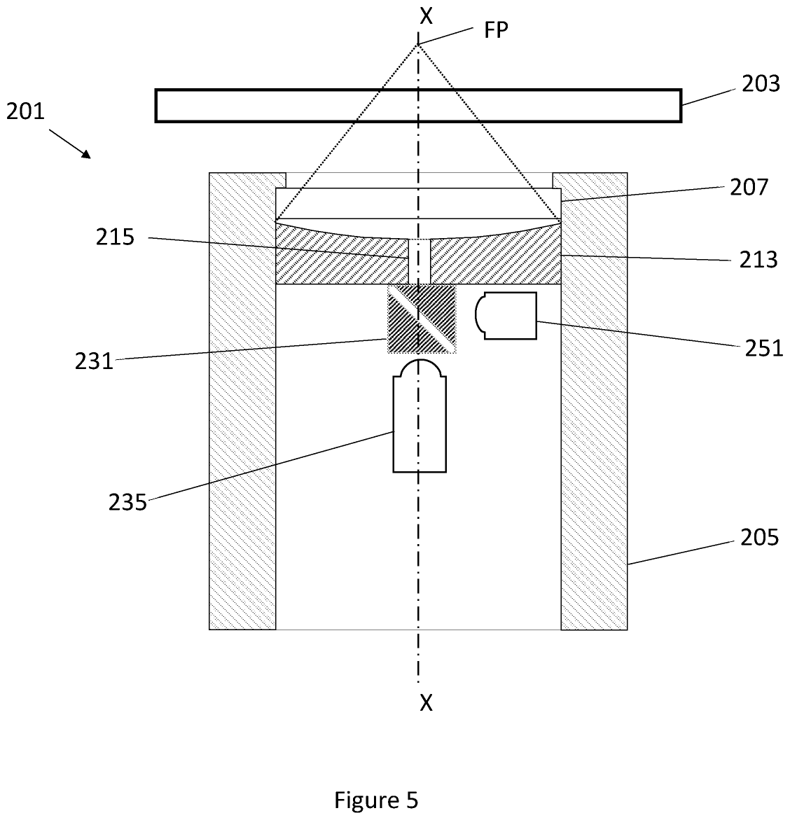

FIG. 5 is a cross-sectional diagrammatic representation of a third embodiment of a non-contact temperature sensor;

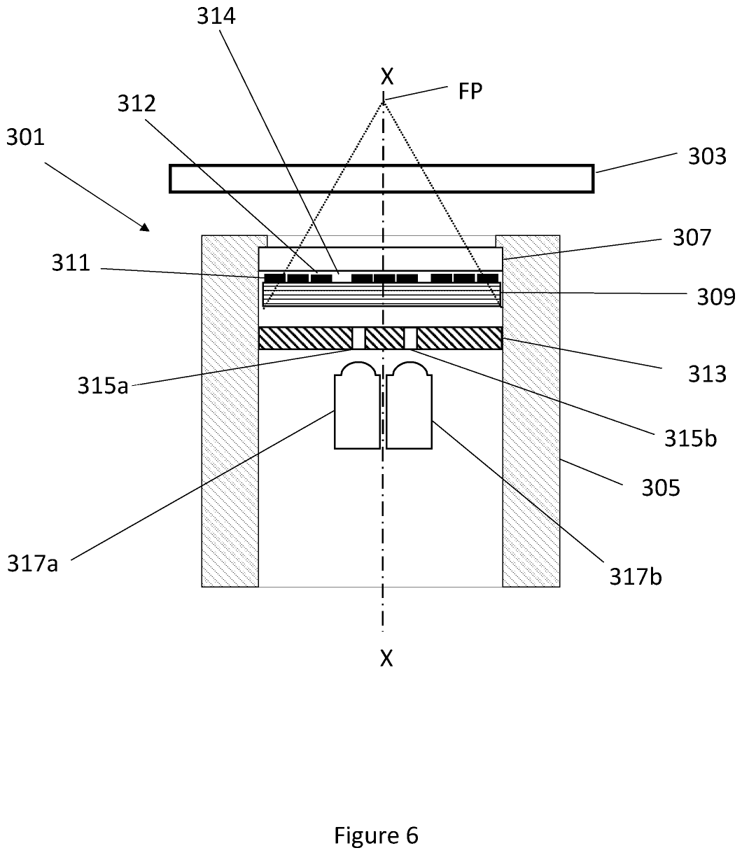

FIG. 6 is a cross-sectional diagrammatic representation of a fourth embodiment of a non-contact temperature sensor;

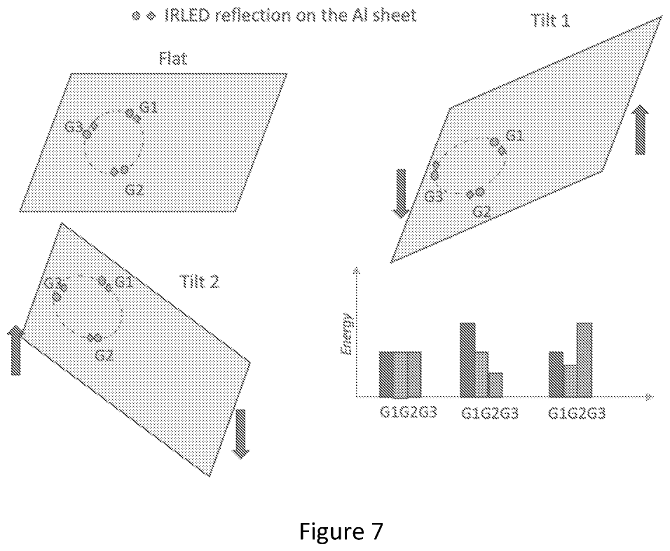

FIG. 7 is a schematic diagram illustrating how the orientation of the blank changes the signal intensity detected for the infrared light sources;

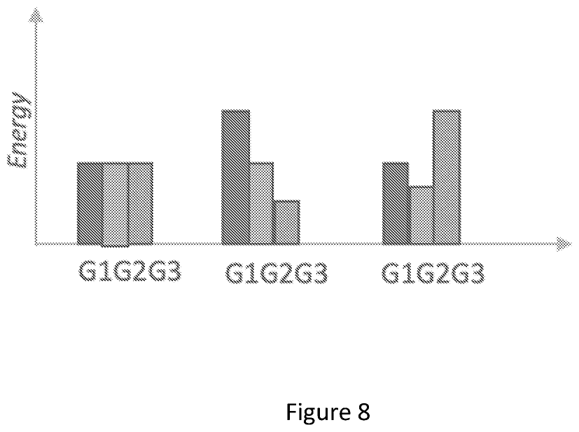

FIG. 8 is a schematic diagram of calibrated relative signal intensity for the three different blank orientations shown in FIG. 7;

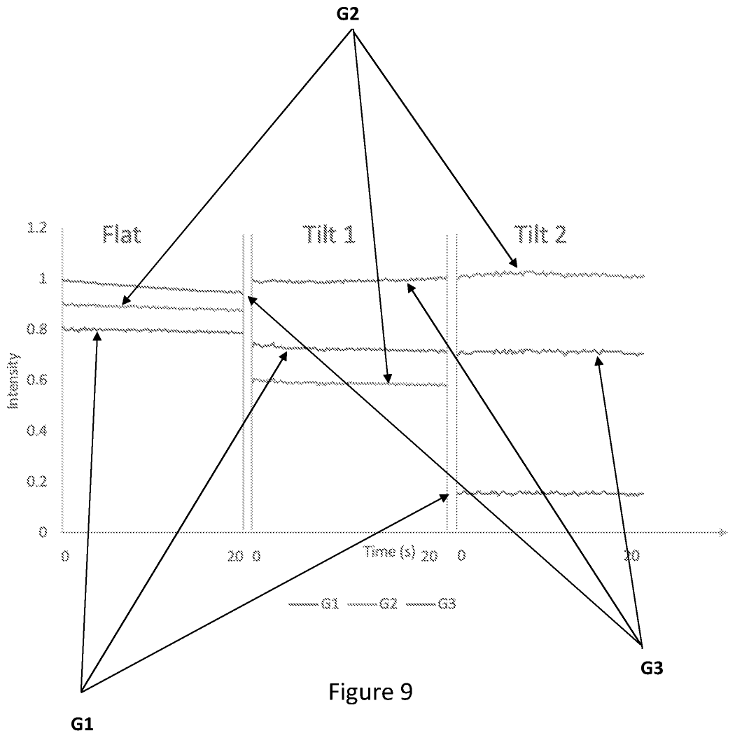

FIG. 9 is a graph showing the relative signal intensities for three different blank orientations;

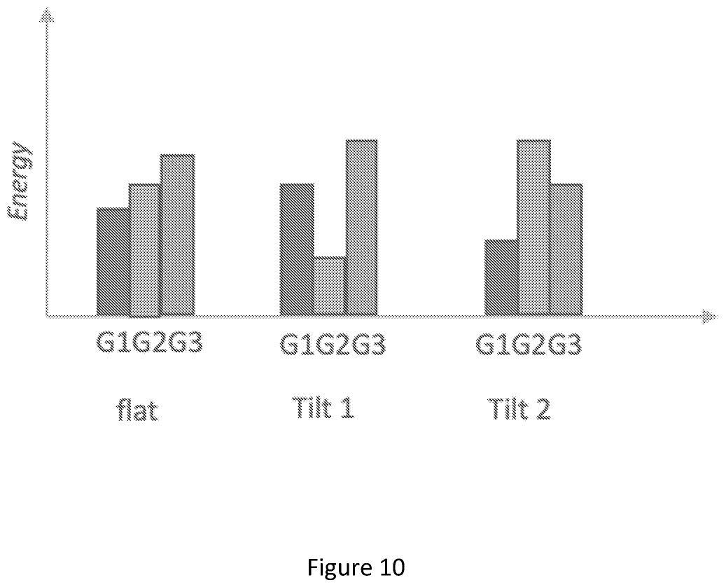

FIG. 10 is a bar chart showing the relative signal intensities for three different blank orientations; and

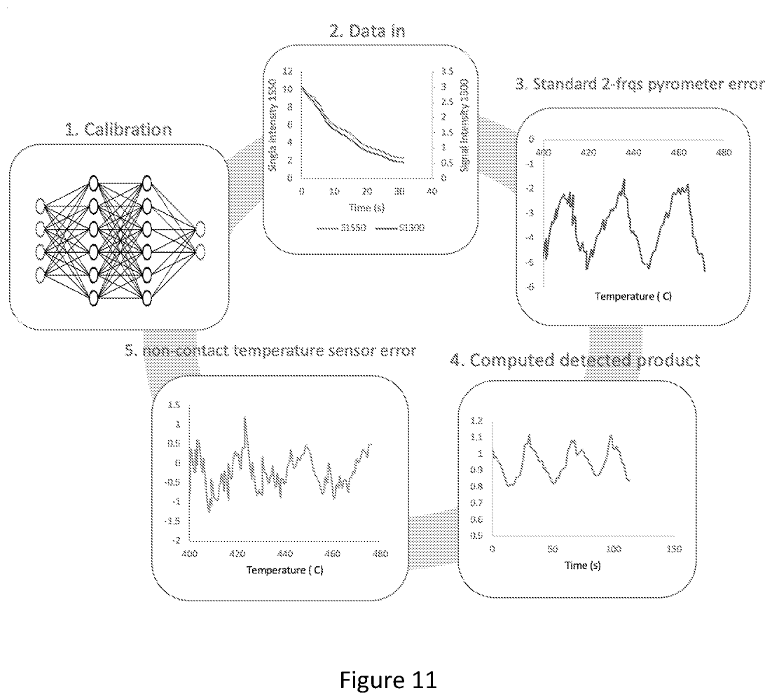

FIG. 11 is a diagram of the non-contact temperature sensor computation process.

A first embodiment of the present invention is shown in FIG. 1. The non-contact temperature sensor 1 is a self-contained device which, in use, is nominally aligned relative to an aluminium alloy blank 3 to be measured, such that the longitudinal axis X-X of the sensor 1 is normal to the planar surface of the blank 3. The sensor 1 comprises a tubular metal housing 5, with a bore of circular cross-section, and it is closed at a forward end by a window 7 formed from a pane of optically transmissive glass. The forward end is the end of the temperature sensor 1 that, in use, is nearest to the blank 3. The rearward end is furthest from the blank 3. An annular lighting ring 9 comprising nine infrared light emitting devices 11, 12, 14 is located rearward of the window 7 and coaxial with the axis X-X. There are three groups of light emitting devices 11, 12, 14, of three different specifications, each specification emitting a different wavelength of light. Group 1 contains the light emitting devices 11 and Group 2 contains the light emitting devices 12. The devices of Group 1 and Group 2 emit light in the infrared spectrum. Group 3 contains the light emitting devices 14 which emit light in the visible spectrum. The light emitting devices 11, 12, 14 are spaced in three clusters of three light emitting devices, Cluster 1 (also referred to as G1), Cluster 2 (also referred to as G2) and Cluster 3 (also referred to as G3). One of each of the light emitting devices 11,12,14 of Group 1, Group 2 and Group 3 are included in each cluster (G1, G2 or G3). The clusters are equidistantly located around the circumference of the annular lighting ring 9. The light emitting devices 11, 12, 14 are orientated such that the light emitted from them is directed in a forward direction, i.e. towards the blank 3. A controller (not shown) for the light emitting devices 11, 12, 14 enables each of the light emitting devices 11, 12, 14 to have its status changed between on and off individually and for the status of the light emitting devices 11, 12, 14 to be changed in a sequence. The control system has the capability of changing the status of the light emitting devices 11, 12, 14 rapidly. The status may be switched at different rates, typically at a rate that is between 1 Hz and 1 kHz. The maximum rate of switching is dependent upon factors such as the maximum switching rate of the devices 11, 12, 14 and the maximum operating frequency of the detection equipment.

A concave gold-plated mirror 13 with a highly reflective surface is also located within the housing 5, rearward of the lighting ring 9 and such that its principal axis is co-axial with the longitudinal axis X-X. The focal point ‘FP’ of the mirror 13 is located on the other side of the blank 3 to the side that is adjacent to the temperature sensor 1, such that, in use, the greatest possible proportion of light reflected by the mirror 13 is incident upon the surface of the blank 3. An aperture 15, that has a relatively small diameter compared to the diameter of the mirror 13, passes through the mirror 13 along the longitudinal axis X-X. In order to focus on to the detector the light passing through the aperture 15 a planar-concave lens 16 is located rearward of the mirror 13, co-axial with the axis X-X and adjacent to the aperture 15 and a bi-convex lens 18 is located rearward of the planar-concave lens 16 and is also co-axial with the axis X-X. All light passing through the planar-concave lens 16 is directed to and passes through the bi-convex lens 18 where it is subjected to further focussing. The light passing through the bi-convex lens 18 is incident upon an infrared light detector 17, which is located in line with the axis X-X. The infrared light detector 17 has a sensor head (not shown) which includes a photodiode assembly with two sensors D1 and D2 and two bandpass filters (not shown). The pool of infrared light that is incident upon the infrared light detector 17 by the bi-convex lens 18 has an area that is substantially the same as the area of the sensor head, so that, in use, infrared light is incident upon the whole of the sensor head. The infrared light detector 17 is able to independently detect two different narrow wavelength ranges of infrared radiation, typically a narrow range centred at 1300 nm and a narrow range centred at 1550 nm. The two wavelengths of infrared light emitted by the infrared light emitting devices 11, 12 are selected so that the infrared light detector 17 can independently detect them and such that cross-talk between the two detection ranges is negligible. The third wavelength of light is emitted by light emitting devices 14 and is selected from the visible light spectrum to assist with setting up and inspecting the device. Preferably a low wavelength light such as blue light may be selected so as to minimise unintentional detection at the infrared light detector 17. The light emitting devices 11, 12 are Infrared Emitting Diodes (IREDs). The light emitting devices 14 are Light Emitting Diodes (LEDs).

The temperature sensor 1 can be located within a gripper (not shown) that is used to hold the blank 3, for example when transferring the blank from the heating device to the forming press. Location of the temperature sensor 1 within the gripper is advantageous because it helps to ensure that a desired distance is maintained between the temperature sensor 1 and the blank 3.

In use, the temperature sensor 1 is located in close proximity to the aluminium alloy blank 3 that has previously been heated to a temperature of several hundred degrees Celsius, typically between 400 degrees Celsius and 600 degrees Celsius, for example between 450 and 550 degrees Celsius. The temperature sensor 1 may be used to monitor the cooling of the blank 3, for example as it cools from 485 degrees Celsius to 350 degrees Celsius. The temperature sensor may monitor the entire cooling curve or may monitor between two temperatures, typically between 550 degrees Celsius and 250 degrees Celsius. The temperature sensor 1 may form part of the cooling control system.

In a second use, the temperature sensor 1 is located in close proximity to the aluminium alloy blank 3 which is heated to a temperature of several hundred degrees Celsius, typically between 400 degrees Celsius and 600 degrees Celsius, for example between 450 and 500 degrees Celsius. The temperature sensor 1 may form part of the heating control system.

When measuring low temperatures, the temperature sensor 1 may use a low-temperature function to extend its lower temperature detection range. Such a function may use only the longer of the two detected wavelength ranges of the infrared light emitted by light emitting devices 11, 12. This is advantageous as it allows for monitoring of low temperatures at which the infrared radiation at the longer wavelength is not detectable above background noise. This cut-off may occur at a temperature between 250 and 350 degrees Celsius. Below the cut-off temperature the low-temperature function may be used to reduce the lower temperature limit of the temperature sensor's 1 detection range. For example, the lower temperature limit may be extended from 300 degrees Celsius down to 250 degrees Celsius using this function.

The distance between the blank 3 and the temperature sensor 1 may be less than 1 mm, or more than 1,000 mm. The distance is typically 10 mm to 100 mm. It is important that variation in distance between the temperature sensor 1 and the blank 3 is minimised or monitored in order to ensure that the temperature measurement is sufficiently accurate. It is also important to know if the blank 3 is normal to the temperature sensor 1, or if it is misaligned. The light emitting devices 11, 12 provided on the annular lighting ring 9 in combination with the infrared light detector 17 can be utilised to detect variation in both the distance between the temperature sensor 1 and the blank 3 and in the orientation between the temperature sensor 1 and the blank 3.

The term device status is used to refer to the settings of the infrared light emitting devices 11, 12 which can be individually set to either ‘on’ or ‘off’. The light emitting device 11,12 status may be switched rapidly. The light emitting device 11,12 status may be switched at a rate of 1 Hz or faster. The device status may be switched at a rate of 100 Hz or faster. For example, the device status may be switched at a rate of 1 kHz. The maximum rate of switching is dependent on factors such as the maximum switching rate of the light emitting device 11,12 and the maximum operating wavelength of the detector 17. A slower switching rate will typically allow multiple samples of the outputs from the detector 17 to be taken which can lead to reduced noise in the detected signals and which in turn can reduce the temperature measurement error. A faster switching rate allows more temperature readings to be taken over a short space of time which may be beneficial, for example, if the blank 3 temperature is changing rapidly.

Calibration is the process used to determine the relationship between the signals outputted from the temperature sensor 1 under various settings of the infrared light emitting devices 11,12 and the temperature of the blank 3 being monitored under various blank temperatures, surface conditions, surface chemistries, deviations in detection angle from the blank surface normal and distance between the blank 3 and the temperature sensor 1. During calibration, the temperature of the blank 3 is known and is recorded, for example, by attaching to the blank 3 and monitoring a calibrated thermocouple temperature measuring device.

In the current embodiment, the temperature sensor 1 is calibrated using a table, The output provides a look-up table that can be interpolated. Other calibration methods are possible, for example, machine learning can be used to develop a black-box method to determine the blank 3 temperature from the various input signals. The data in the look-up table may be interpolated using a multi-parameter equation set, such as a set of polynomial equations or a multi-dimensional parametric equation.

During calibration, the temperature sensor 1 is capable of detecting multiple useful calibration states. Calibration data may be collected using the temperature sensor 1 itself or may be transferred from a sister temperature sensor.

For many combinations of the various blank 3 conditions, the outputs of the infrared light detector 17 for wavelength range 1 and wavelength range 2 are recorded whilst cycling through light emitting device 11, 12 states. At least one cycle is completed for each combination of blank 3 conditions.

In the current example, the device states are: all infrared light emitting devices 11, 12 (IREDs) OFF; all infrared light emitting devices 11 (IREDs) in Cluster 1 ON, all others OFF; all infrared light emitting devices 12 (IREDs) in Cluster 2 ON, all others OFF; all infrared light emitting devices 12 (IREDs) in Cluster 3 ON, all others OFF. Thus, a single cycle of infrared light emitting device 11, 12 states has four discreet infrared light emitting device 11, 12 states. The light emitting devices 14 (LEDs) in the visible wavelength spectrum are not used in this calibration example and may be either on or off.

It is an objective of the calibration exercise to obtain a data cloud of signal output data points within the multidimensional space created by varying the blank characteristics and parameters of: surface temperature; surface texture; surface chemistry; deviations in detection angle from the blank surface normal; and distance between the blank and the temperature sensor 1. The characteristics and parameters are chosen to reflect the range of expected and extreme conditions for which the temperature sensor 1 is expected to operate. This includes instances in which no blank is present and in which a cold blank is presented in front of the window 7.

In the example calibration system described, it is not necessary to record the blank characteristics and parameters other than the blank temperature. This is because such data is not explicit within the calibration data set.

It is advantageous to cycle through the light emitting device 11, 12 states and this contributes implicit data within the data cloud relating to the distance of the blank 3 from the temperature sensor 1 and the deviation in angle from normal between the blank 3 and the temperature sensor 1. When the light emitting devices 11, 12 (IREDs) are switched on the infrared light emitted by them becomes incident upon the blank 3. The blank 3 reflects the infrared light from the light emitting devices 11, 12 such that it is incident upon the mirror 13, the mirror 13 then reflects that infrared light back to the blank 3. A series of such reflections takes place and infrared light passes through the aperture 15 and is detected by the infrared light detector 17 which measures the intensity of that infrared light. Data points collected with the blank in close proximity to the temperature sensor 1 and with the blank normal to the temperature sensor 1 X-X axis will show even, strong signal strength for each of the three IRED clusters. The signal strength will be detected as increased signal outputs from the detection device. In a first comparison, a blank tilted from the normal plane of axis X-X will lead to variation in signal strength between each of the three clusters of light emitting devices 11, 12 (IREDs), as the reflection about axis X-X will no longer be symmetrical. In a second comparison, a blank 3 positioned further from the temperature sensor 1 will result in a less prominent increase in signal outputs from the infrared detector 17.

The reason the above data is advantageous is that the exact effect of the mirror 13 on the infrared light reaching the infrared detector 17 is dependent on both the angle of the blank and the distance of the blank from the temperature sensor 1. Using the above method, such effects are implicitly captured within the calibration data cloud.

The use of two different light emitting devices 11, 12 that emit infrared light at two different wavelengths increases the accuracy with which the temperature can be derived because it provides data implicitly capturing the performance of the mirror 13 at both wavelengths of infrared light emitted by devices 11, 12. Under other configurations, the additional data can be used to provide diagnostics on the performance of the temperature sensor 1.

It is an output of the calibration exercise to produce a calibration table which, on each row, is listed in individual columns the outputs of the temperature sensor 1 under each of the four discreet infrared light emitting device 11, 12 states that form a cycle. As there are two wavelength range outputs for each light emitting device 11, 12 state, the table will have 8 columns. On a final 9^{th} column the blank surface temperature, as measured using the calibrated temperature measuring device 1, is recorded.

Some post-processing of the resulting table may be conducted, for example, to remove outlying data, to average data points that approximately overlap within the multidimensional data cloud or to smooth the data cloud.

An example is now given as to how the above calibrated temperature sensor 1 may be used to monitor the temperature of blank 3.

The visible wavelength light emitting devices 14 (LEDs) are illuminated to provide visual feedback that the temperature sensor 1 is on and pointing towards the area of interest on the blank 3.

The light emitting device 11, 12 states as described above are cycled through. For example, each light emitting device 11, 12 state may be active for 100 ms or 10 ms before the light emitting device 11, 12 state is updated to the next state.

Whilst the temperature sensor 1 is cycling through the light emitting device 11, 12 states, the output signals from the infrared detector 17 are monitored. On completion of a cycle, the output signals correlating to each of the four light emitting device 11, 12 states are compared with the look-up table. A look-up algorithm is used to identify the closest entries from the calibration table, together with the corresponding blank temperatures. An extrapolation is performed to calculate a new extrapolated calibration table row. The number in the resulting temperature column is given as the measured temperature of blank 3. The temperature may be recorded against a timestamp for recording purposes. The temperature may be passed to other equipment, for example, to provide an accurate temperature measurement for the calibration of a thermal imaging camera.

Preferentially, data relating to the extrapolation process is captured and used to estimate the error within the temperature reading. For example, the upperbound and lowerbound temperatures from the table closest entries may be used to provide information as to the potential range of the actual surface temperature of blank 3.

To determine the orientation and degree of any misalignment the infrared light emitting devices 11, 12 can be switched on in a sequence and light intensity measurements can be taken by the infrared detector 17 at time points in that sequence that correspond with the turning on and off of the infrared light emitting devices 11, 12. Those light intensity measurements can be processed to determine which way the blank 3 is tilted and by how much.

The three clusters G1, G2 and G3 of infrared light sources 11, 12, are provided on the annular lighting ring 9 and equally spaced around its perimeter. The two detectors D1 and D2 of infrared light detector 17 are each able to detect the intensities of the signal from each of the two infrared light sources 11, 12 within each of the three clusters G1, G2 and G3. In the schematic of FIG. 7 it is assumed that the behaviour of the clusters G1, G2 and G3 is similar for each of the two wavelengths used. The infrared light sources 11,12 in the clusters G1, G2 and G3 are switched on and off and thus it is possible to measure the intensities of the signals from each of the infrared light sources 11, 12. The activation sequences are shown in the tables below.

TABLE 1
Activation sequences for the three groups of LED in the light ring

| Activation | | | | | | |
|---|---|---|---|---|---|---|
| Sequence | G1_1300 | G2_1300 | G3_1300 | G1_1550 | G2_1550 | G3_1550 |
| 1 | Off | Off | Off | Off | Off | Off |
| 2 | On | Off | Off | On | Off | Off |
| 3 | Off | On | Off | Off | On | Off |
| 4 | Off | Off | On | Off | Off | On |

TABLE 2
Signals detected during the four activation sequences

| Activation | | |
|---|---|---|
| Sequence (AS) | Detector 1300 | Detector 1550 |
| 1 | Thermal Energy | Thermal Energy |
| 2 | Thermal Energy + G1 | Thermal Energy + G1 |
| 3 | Thermal Energy + G2 | Thermal Energy + G2 |
| 4 | Thermal Energy + G3 | Thermal Energy + G3 |

If the detector readings are taken sufficiently fast such that the blank temperature can be assumed constant, the energy related to clusters G1, G2 and G3 can be calculated as:

$${G}_{N , W} = A {S}_{N + 1 , W} - A {S}_{1 , W} \qquad [ Equation 1 ]$$

in which N is the cluster number 1-3 and W is the wavelength, in this case 1300 nm or 1550 nm.

In these examples the clusters G1, G2 and G3 each have two discrete infrared light sources 11,12, as shown in FIG. 7. One of those infrared light sources 11, 12 has a wavelength of 1300 nm. The other of the infrared light sources 11, 12 has a wavelength of 1550 nm.

If the blank 3 is oriented so that it is exactly perpendicular to the non-contact temperature sensor 1 and the respective signal intensity is calibrated, then the amount of energy that the non-contact temperature sensor 1 detects from each of the clusters G1, G2 and G3 is substantially the same (as seen in the left hand part of the bar chart of FIG. 8).

If the blank 3 is tilted, i.e. it is not exactly perpendicular to the non-contact temperature sensor 1 then the amount of energy that the non-contact temperature sensor 1 detects from each of the clusters G1, G2 and G3 is different and that can be related to the angle of tilt (as seen in the middle and right parts of the bar chart of FIG. 8). In one tilted orientation the amount of energy detected from cluster G1 will be the highest detected. In the other tilted orientation the amount of energy detected from cluster G3 will be the highest detected. The relevance of this to the measurement of the temperature of the blank 3 is that if the blank 3 is tilted then the measured temperature will be inaccurate.

FIG. 9 is a graph of the individual cluster intensities G1, G2 and G3, as calculated in Equation 1 (as above), and normalised for the maximum signal strength (hence the maximum value is 1). The data was collected by holding a hot blank 3 in front of the non-contact temperature sensor 1 positioned in three different orientations: ‘Flat’; ‘Tilt 1’; and ‘Tilt 2’. This illustrates that (i) the energy emitted by the light source 11,12 is approximately constant with time for each configuration (hence, it allows for future calculations) and (ii) the intensity for the three clusters, G1, G2 and G3 varies depending on the orientation. This shows that the non-contact temperature sensor 1 is able to detect a tilt in the blank 3 based on the relative intensities of the three clusters G1, G2 and G3.

FIG. 10 is a bar chart showing the energy detected by the non-contact temperature sensor 1 for the three clusters G1, G2 and G3 for the flat blank 3 (‘Flat’) and the two tilted blanks 3 (‘Tilt 1’ and ‘Tilt 2’).

FIG. 11 illustrates the process by means of which the non-contact temperature sensor 1 has better temperature accuracy compared with standard known two-frequency pyrometers. An initial calibration with a neural network, shown in Item 1 of FIG. 11, can be used to compute different combinations of intensity of the three clusters G1, G2 and G3, for different tilt angles and blank surface finishes.

The data shown was collected by holding a hot blank 3 in front of the non-contact temperature sensor 1. The blank 3 was subject to oscillation movement during the period over which the data was collected to demonstrate the effect of tilt onto the temperature measurement and comparing standard two-frequency pyrometers with the non contact temperature sensor 1 of the present invention.

The oscillation of the blank 3 and the subsequent intensity detected is shown in the graph of Item 2 of FIG. 11. The signal intensity is plotted against time for both the 1300 nm and 1550 nm wavelength infrared light sources 11,12, which each exhibit a waviness.

The temperature error determined by the standard two-frequency pyrometer against time is shown in Item 3 of FIG. 11. The error varies because of the movement of the blank 3.

The non-contact temperature sensor 1 has extra features, such as the clusters G1, G2 and G3 of infrared light sources 11,12 for the two different wavelengths, and thus the extra data was used to calculate a computed detected product which is related to the angle at which the blank 3 is tilted relative to the non-contact temperature sensor 1.

The use of this new methodology and incorporation of the calculation means that it is possible to reduce the temperature error as shown in Item 5 of FIG. 11.

A second embodiment of the present invention is shown in FIG. 4. The non-contact temperature sensor 101 is also a self-contained device that shares a number of features with the first embodiment and it is intended to be orientated in use relative to a blank 103 in the same way. The temperature sensor 101 has the same tubular metal housing 105, window 107, mirror 113 and mirror aperture 115 as the first embodiment. In addition, it has a beam splitter 131 which is located rearward of the mirror 109 such that it can receive light passing through the aperture 115. The beam splitter 131 splits the infrared light emitted from the blank 3 into a transversal component that extends perpendicularly to the longitudinal axis X-X and a longitudinal component that extends along or parallel to the longitudinal axis X-X. A first optical filter 133 is arranged within the housing 105 such that the longitudinal component of the light is filtered before it reaches a first infrared detector 135, which is located within the bore of the housing 105. A second optical filter 137 is arranged within the housing 105 such that the transversal component of the light is filtered before it reaches a second infrared detector 139, which is located within an aperture in a side wall of the housing 105. The first infrared detector 135 and the second infrared detector 139 have the same bandwidth, which is 900 to 1700 nm. The first optical filter 133 is a narrow-pass filter which allows infrared radiation with a wavelength of 1300 nm to pass through it. The second optical filter 137 is a narrow-pass filter which allows infrared radiation with a wavelength of 1550 nm to pass through it.

In use, the temperature sensor 101 is located in close proximity to an aluminium alloy blank 103 that has been heated to a temperature of several hundred degrees Celsius. Infrared radiation emitted by the blank 103 passes through the window 107 and is incident upon the mirror 113. That infrared radiation is reflected back to the surface of the blank 103, multiple times in the same manner as in the first embodiment and for the same reasons. The infrared radiation will pass through the aperture 115 in the mirror 113 and will contact the beam splitter 131. The beam splitter 131 will send a portion of the infrared radiation towards the first infrared light detector 135. The infrared radiation sent towards the first infrared light detector 135 passes through a first optical filter 133. The first optical filter 133 permits only infrared radiation with a wavelength of 1300 nm to reach the first infrared light detector 135. The beam splitter 131 will send another portion of the infrared radiation towards the second infrared light detector 139. The infrared radiation sent towards the second infrared light detector 139 passes through the second optical filter 137. The second optical filter 137 permits only infrared radiation with a wavelength of 1550 nm to reach the second infrared light detector 139.

A third embodiment of the present invention is shown in FIG. 5. The non-contact temperature sensor 201 is also a self-contained device that shares a number of features with the first and second embodiments and it is intended to be orientated in use relative to a blank 203 in the same way. The temperature sensor 101 has the same tubular metal housing 205, window 207, mirror 213 and mirror aperture 215 as the first embodiment. In addition, it has a beam splitter 231 which is located rearward of the mirror 109 such that it can receive light passing through the aperture 115. The beam splitter 231 acts as an angled reflector. A two wavelength light source 251 is located transversally of the angled reflector 231 and is aligned with it such that any infrared radiation from the light source 251 strikes the angled reflector 231 and is deflected through the aperture 215 towards the aluminium alloy blank 203. The light source 251 generates infrared radiation in two discrete wavelengths, each of those wavelengths being detectable by a two-wavelength infrared light detector 235, described in further detail below. The angled reflector 231 directs electromagnetic radiation from the light source 251 through the aperture 215 so that it contacts the blank 203. The two-wavelength infrared light detector 235 is located rearward of the concave mirror 213 and is capable of detecting infrared radiation having a wavelength of 1300 nm or 1550 nm. The two-wavelength infrared light detector 235 has a narrow bandwidth around the two desired wavelength and so there is no need to place an optical filter in front of the detector 235.

In use, to determine the temperature of an aluminium alloy blank 203, the temperature sensor 201 operates in a similar way to that of the first embodiment. The temperature sensor 201 is located in close proximity to the blank 203 that has been heated to a temperature of several hundred degrees Celsius.

The third embodiment includes a means to measure the distance between the blank 203 and the temperature sensor 1 using any suitable method, such as radar, lidar or a mechanical measuring apparatus. Once the distance between the blank 203 and the temperature sensor 201 has been determined that distance can be used during the process of producing a temperature measurement from the intensity of infrared light emitted by the blank 203 itself, as a result of the blank 203 being at an elevated temperature.

A fourth embodiment of the invention is shown in FIG. 6. The fourth embodiment shares a number of features with the first embodiment. The non-contact temperature sensor 301 is a self-contained device which, in use, is nominally aligned relative to an aluminium alloy blank 3 to be measured, such that the longitudinal axis X-X of the sensor 301 is normal to the planar surface of the blank 303. The sensor 301 comprises a tubular metal housing 305, with a bore of circular cross-section, and it is closed at a forward end by a window 307 formed from a pane of optically transmissive glass. The forward end is the end of the temperature sensor 301 that, in use, is nearest to the blank 303. The rearward end is furthest from the blank 303. An annular lighting ring 309 comprising nine infrared light emitting devices 311, 312, 314 is located rearward of the window 307 and coaxial with the axis X-X. There are three groups of light emitting devices 311, 312, 314, of three different specifications, each specification emitting a different wavelength of light. Group 1 contains the light emitting devices 311 and Group 2 contains the light emitting devices 312. The devices of Group 1 and Group 2 emit light in the infrared spectrum. Group 3 contains the light emitting devices 14 which emit light in the visible spectrum. The light emitting devices 311, 312, 314 are spaced in three clusters of three light emitting devices, Cluster 1, Cluster 2 and Cluster 3. One of each of the light emitting devices 311,312,314 of Group 1, Group 2 and Group 3 are included in each cluster. The clusters are equidistantly located around the circumference of the annular lighting ring 309. The light emitting devices 311, 312, 314 are orientated such that the light emitted from them is directed in a forward direction, i.e. towards the blank 303. A controller (not shown) for the light emitting devices 311, 312, 314 enables each of the light emitting devices 311, 312, 314 to have its status changed between on and off individually and for the status of the light emitting devices 311, 312, 314 to be changed in a sequence. The control system has the capability of changing the status of the light emitting devices 311, 312, 314 rapidly. The status may be switched at different rates, typically at a rate that is between 1 Hz and 1 kHz. The maximum rate of switching is dependent upon factors such as the maximum switching rate of the devices 311, 312, 314 and the maximum operating frequency of the detection equipment.

A flat gold-plated mirror 313 with a highly reflective surface is also located within the housing 305, rearward of the lighting ring 309 and such that its principal axis is co-axial with the longitudinal axis X-X. Two apertures 315a and 315b, that each have a relatively small diameter compared to the diameter of the mirror 313, pass through the mirror parallel to the longitudinal axis X-X. The distance between the longitudinal axes of each of the apertures 315a, 315b is one fifth of the diameter of the mirror 313. The separation distance is selected such that there is sufficient space to house the light detectors 317a, 317b , whilst keeping the apertures close to each other so that the measurement points on the blank are sufficiently near to each other to ensure consistent temperature measurements from approximately the same point on the blank. A typical mirror diameter is 50 mm and a typical aperture diameter is between 0.1 mm and 5 mm. The light passing through each of the apertures 315a, 315b is incident upon an infrared light detector 317a, 317b respectively, which are each located in line with the longitudinal axis of the aperture. The infrared light detectors 317a, 317b each have a sensor head (not shown) which includes a photodiode assembly with a sensor and a bandpass filter (not shown). The pool of infrared light that is incident upon the infrared light detectors 317a, 317b has an area that is substantially the same as the area of the sensor head, so that, in use, infrared light is incident upon the whole of the sensor head. The infrared light detectors 317a, 317b are each able to independently detect a different narrow wavelength range of infrared radiation, typically a narrow range centred at 1300 nm and a narrow range centred at 1550 nm. The two wavelengths of infrared light emitted by the infrared light emitting devices 311, 312 are selected so that the infrared light detectors 317a, 317b can independently detect them and such that cross-talk between the two detection ranges is negligible. The third wavelength of light is emitted by light emitting devices 314 and is selected from the visible light spectrum to assist with setting up and inspecting the device. Preferably a low wavelength light such as blue light may be selected so as to minimise unintentional detection at the infrared light detectors 317a, 317b. The light emitting devices 311, 312 are Infrared Emitting Diodes (IREDs). The light emitting devices 314 are Light Emitting Diodes (LEDs).

1. A non-contact temperature sensor having a longitudinal axis X-X comprising:
a housing;
an opening at the forward end of the housing;
a reflector that is located within the housing;
at least one aperture that is located between the forward surface and the rearward surface of the reflector;
a light detector arrangement located rearward of the reflector;
wherein the light detector arrangement is orientated such that it can receive light passing through the at least one aperture; wherein
the light detector arrangement is capable of detecting at least two ranges of wavelengths of infrared light, a first range of wavelengths of infrared light and a second range of wavelengths of infrared light, the first and second ranges of wavelengths of infrared light being discrete; and wherein
the light detector arrangement outputs data for each of the at least two ranges of wavelengths of infrared light.

2. The non-contact temperature sensor as claimed in claim 1 further comprising an infrared light source.

3. The non-contact temperature sensor as claimed in claim 2 comprising two infrared light sources, a first infrared light source configured to generate infrared light at a first wavelength and a second infrared light source configured to generate infrared light at a second wavelength.

4. The non-contact temperature sensor as claimed in claim 3 wherein the first and second wavelengths of infrared light generated by the infrared light sources are respectively within the first range of wavelengths of infrared light and the second range of wavelengths of infrared light that are detectable by the light detector arrangement.

5. The non-contact temperature sensor as claimed in claim 3, wherein the infrared light sources are located forward of the mirror.

6. The non-contact temperature sensor as claimed in claim 5 wherein the infrared light sources comprise a plurality of separate infrared light emitting devices arranged individually, or in discrete groups, and orientated so that the individual infrared light emitting devices or the discrete groups of infrared light emitting devices are spaced apart from each other.

7. The non-contact temperature sensor as claimed in claim 6 wherein the plurality of separate infrared light emitting devices are located on the forward facing side of an annular platform that is orientated transversally to the axis X-X and aligned co-axially with the longitudinal axis X-X.

8. The non-contact temperature sensor as claimed in claim 1, wherein the light detector arrangement is an arrangement of two or more discrete light detectors within a single light detection module, and wherein one of the two or more discrete light detectors is capable of detecting infrared light within the first range of wavelengths of infrared light and wherein the other of the two or more discrete light detectors is capable of detecting infrared light within the second range of wavelengths of infrared light.

9. The non-contact temperature sensor as claimed in claim 1, wherein the light detector arrangement is an arrangement of two or more discrete light detectors, each detector within a separate light detection module, and wherein one of two or more discrete light detectors is capable of detecting infrared light within the first range of wavelengths of infrared light and wherein the other of the two or more discrete light detectors is capable of detecting infrared light within the second range of wavelengths of infrared light.

10. The non-contact temperature sensor as claimed in claim 1, further comprising at least one lens aligned with the longitudinal axis X-X and located adjacent to and rearward of the at least one aperture.

11. The non-contact temperature sensor as claimed in claim 10 wherein the at least one lens is a planar-concave lens aligned with the longitudinal axis X-X, or aligned with an axis parallel to the longitudinal axis X-X, and located rearward of the at least one aperture.

12. The non-contact temperature sensor as claimed in claim 10 further comprising at least one bi-convex lens aligned with the longitudinal axis X-X or aligned with an axis parallel to the longitudinal axis X-X, and located rearward of the at least one aperture.

13. The non-contact temperature sensor as claimed in claim 1, wherein the reflector is a concave mirror.

14. The non-contact temperature sensor as claimed in claim 13, wherein the mirror has a focal point (FP) that is outside of the housing.

15. The non-contact temperature sensor as claimed in claim 13 wherein a focal point (FP) of the mirror is positioned at a distance of between 50 mm and 100 mm from the forward face of the housing.

16. The non-contact temperature sensor as claimed in claim 1, wherein the light detector arrangement is orientated in a direct line of sight with the at least one aperture.

17. The non-contact temperature sensor as claimed in claim 1, wherein the opening is a window made from a high transmissivity material.

18. The non-contact temperature sensor as claimed in claim 1, further comprising a visible light source that can generate light in the visible range, wherein the visible light from the visible light source is directed in a forward direction.

19. The non-contact temperature sensor as claimed in claim 3 further comprising a controller for controlling the infrared light sources.

20. The non-contact temperature sensor as claimed in claim 19 wherein the controller is capable of switching of the light emitting devices from an ON state to an OFF state.
